(19) United States
(12) Patent Application Publication
(10) Pub. No.: US 2026/0371089 A1
(43) Pub. Date: Nov. 19, 2026

(54) APPLICATION PROGRAM INTERFACE (API) INVOKING METHOD AND APPARATUS, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(21) Appl. No.: 19/103,156

(22) PCT Filed: Aug. 12, 2022
(86) PCT No.: PCT/CN2022/112333

§ 371 Date: Feb. 11, 2025

(51) Int. Cl. H04W 12/084; G06F 9/54

(52) U.S. Cl. CPC H04W 12/084; G06F 9/547

(57) ABSTRACT

Provided in the present disclosure are an application program interface (API) invoking method and apparatus, and a storage medium. The API invoking method comprises: in response to a UE having generated or updated an authorization configuration file, sending a setting request message to an access and mobility management function (AMF), wherein the authorization configuration file is used for authorizing other UEs or application functions (AFs) to acquire, modify or set a target resource of the UE, and the setting request message is used for requesting that updated file information content in the authorization configuration file is synchronized to unified data management (UDM); and receiving a setting response message returned by the AMF, wherein the setting response message is used for notifying the UE that the updated file information content has been synchronized to the UDM.

### CROSS REFERENCE TO RELATED APPLICATIONS

The present application is a U.S. National Stage of International Application No. PCT/CN2022/112333 filed on Aug. 12, 2022, the content of which is incorporated herein by reference in its entirety.

### TECHNICAL FIELD

The present disclosure relates to the field of communications, and in particular, to an application program interface (API) invoking method and apparatus, and a storage medium.

### BACKGROUND

One of goals of security researches on application enablement of Subscriber-aware Northbound API access (SNA) (SNAAPP security) is to obtain authorization from resource owners. Current provisions allow UEs to provide consent and/or revoke consent for sharing information (e.g., location, presence) with third parties. In addition, in an SNA scenario, an application program interface (API) invoker may request consent for acquisition or setting of resources (e.g., location, presence) owned by itself. However, in an API invoking scenario, there is no related mechanism to enable user authorization for the API invoker to obtain or set a target resource.

### SUMMARY

According to a first aspect of the embodiments of the present disclosure, an application programming interface (API) invoking method is provided, performed by a user equipment (UE), including:
sending a setting request message to an Access and Mobility Management Function (AMF) in response to the UE generating or updating an authorization configuration file, wherein the authorization configuration file is for authorizing other UEs or Application Function (AFs) to obtain, modify, or set a target resource of the UE, and the setting request message is for requesting to synchronize updated file information content in the authorization configuration file to a Unified Data Management (UDM); and
receiving a setting response message returned by the AMF, wherein the setting response message is for notifying the UE that the updated file information content has been synchronized to the UDM.

According to a second aspect of the embodiments of the present disclosure, an application programming interface (API) invoking method is provided, performed by an API invoker, including:
sending an authorization request message to a Common API Framework for 3GPP Northbound APIs (CAPIF) authentication and authorization function, wherein the authorization request message is for requesting to obtain authorization of a target resource;
receiving an authorization response message returned by the CAPIF authentication and authorization function, wherein the authorization response message is for indicating whether a target resource owner agrees to an authorization request of the API invoker;
if the authorization response message indicates that the target resource owner agrees to the authorization request of the API invoker, sending a service API invocation request message to an API Exposure Function (AEF) based on a token provided by the CAPIF authentication and authorization function, wherein the token is for authorizing the API invoker to obtain, modify, or set the target resource; and
receiving a service API invocation response message returned by the AEF, wherein the service API invocation response message carries the target resource.

According to a third aspect of the embodiments of the present disclosure, an application programming interface (API) invoking method is provided, performed by a Common API Framework for 3GPP Northbound APIs (CAPIF) authorization function, including:
receiving an authorization request message sent by an API invoker, wherein the authorization request message is for requesting to obtain authorization of a target resource;
determining, according to an authorization configuration file corresponding to a target resource owner, whether the target resource owner agrees to the authorization request of the API invoker; and
sending an authorization response message to the API invoker, wherein the authorization response message is for indicating whether the target resource owner agrees to the authorization request of the API invoker.

According to a fourth aspect of the embodiments of the present disclosure, an application programming interface (API) invoking apparatus is provided, including:
a processor; and
a memory for storing processor-executable instructions;
wherein the processor is configured for performing the application programming interface (API) invoking method according to any one of the foregoing embodiments in the UE side.

It should be understood that the above general description and the following detailed description are only for example and explanation, and do not limit the present disclosure.

### BRIEF DESCRIPTION OF DRAWINGS

Accompanying drawings, which are incorporated in and constitute a part of this specification, illustrate embodiments consistent with the present disclosure and together with the description serve to explain principles of the present disclosure.

FIG. 1 is a schematic flowchart of an application program interface API invoking method according to an example.

FIG. 2 is a schematic flowchart of another application program interface API invoking method according to an example.

FIG. 3 is a schematic flowchart of another application program interface API invoking method according to an example.

FIG. 4 is a schematic flowchart of another application program interface API invoking method according to an example.

FIG. 5 is a schematic flowchart of another application program interface API invoking method according to an example.

FIG. 6 is a schematic flowchart of another application program interface API invoking method according to an example.

FIG. 7 is a schematic flowchart of another application program interface API invoking method according to an example.

FIG. 8 is a schematic flowchart of another application program interface API invoking method according to an example.

FIG. 9 is a block diagram of an application program interface API invoking apparatus according to an example.

FIG. 10 is a block diagram of another application program interface API invoking apparatus according to an example.

FIG. 11 is a block diagram of another application program interface API invoking apparatus according to an example.

FIG. 12 is a block diagram of another application program interface API invoking apparatus according to an example.

FIG. 13 is a block diagram of another application program interface API invoking apparatus according to an example.

FIG. 14 is a block diagram of another application program interface API invoking apparatus according to an example.

FIG. 15 is a structural block diagram of a communication system according to an example.

FIG. 16 is a schematic structural diagram of an application program interface API invoking apparatus according to an example of the present disclosure.

FIG. 17 is a schematic structural diagram of another application program interface API invoking apparatus according to an example of the present disclosure.

### DETAILED DESCRIPTION

Examples will be described in detail herein, examples of which are illustrated in the accompanying drawings. Where the following description refers to the drawings, unless otherwise indicated, like numerals in different drawings indicate the same or similar elements. The embodiments described in the following examples do not represent all embodiments consistent with the present disclosure. Rather, they are merely examples of devices and methods consistent with some aspects of the present disclosure as detailed in the appended claims.

Terminology used in the present disclosure is for the purpose of describing particular embodiments only and is not intended to limit the present disclosure. Singular forms “a”, “the”, and “said” used in the present disclosure and the appended claims are also intended to include plural forms unless the context clearly indicates other meanings. It should also be understood that the term “and/or” as used herein refers to and includes any or all possible combinations of at least one associated listed item.

It should be understood that although the terms “first”, “second”, “third”, etc. may be used in the present disclosure to describe various information, these information should not be limited to these terms. These terms are only used to distinguish the same type of information from each other. For example, first information may also be referred to as second information without departing from the scope of the present disclosure, and similarly the second information may also be referred to as the first information. Depending on context, the word “if” as used herein may be interpreted as “when” or “upon” or “in response to determining.”

In the present disclosure, it may be assumed that a user equipment (UE) is a target resource owner, and an API invoker is another UE or an application function (AF) in an SNA scenario. The API invoker obtains a target resource of the target resource owner based on user authorization, where the API invoker is a target resource requester.

The following first describes, from a UE side, an application program interface API invoking method provided in the present disclosure.

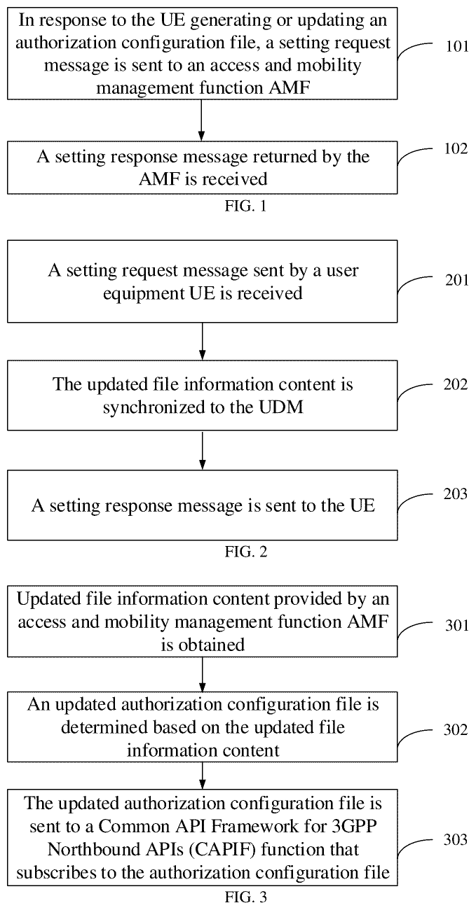

An embodiment of the present disclosure provides an application program interface API invoking method. Referring to FIG. 1, FIG. 1 is a flowchart of an application program interface API invoking method according to an embodiment. The method can be performed by a UE which serves as a target resource owner, and include the following steps.

In step 101, in response to the UE generating or updating an authorization configuration file, a setting request message is sent to an access and mobility management function AMF.

In the embodiment of the present disclosure, a default Common API Framework for 3GPP Northbound APIs (CAPIF) function may subscribe to a unified data management (UDM) notification from a UDM. The UDM notification is used to indicate that the authorized configuration file is updated. The CAPIF function includes but is not limited to a CAPIF authentication authorization function and an API Exposure Function (AEF). Specifically, the CAPIF authentication authorization function may include but is not limited to a CAPIF core function (CCF) or an authorization function. Or the CAPIF authentication authorization function may be implemented by network functions deployed by an operator, and the CAPIF authentication authorization function may include but is not limited to a network Exposure Function (NEF).

In the embodiment of the present disclosure, the authorization configuration file is used to authorize other UEs or application functions (Afs) to obtain, modify or set a target resource of the UE.

When the authorization configuration file has been generated or the generated authorization configuration file has been updated, the UE may send a setting request message to an Access and Mobility Management Function (AMF), where the setting request message is used to request to synchronize file information content updated in the authorization configuration file to the UDM.

In an implementation, the UE may send a first Non-Access Stratum (NAS) message based on a N1 interface to the AMF.

In an implementation, the authorization configuration file includes at least one of: a token type that needs to be authorized to the API invoker; an identifier of the API invoker; an identifier of an expected service API; an identifier of a service that the API invoker is allowed to request; an identifier of a service operation that the API invoker is allowed to request; an identifier of the target resource that the API invoker is allowed to request; an identifier of a target resource owner; a geographical area that the API invoker should be in when accessing the target resource; and an authorization expiration time point.

The token type that needs to be authorized to the API invoker includes but is not limited to a refresh token and an access token.

The identifier of the API invoker may include but is not limited to the following three types.

A first type is a terminal identifier of the API invoker, including but not limited to an IP Multimedia Private Identity (IMPI) of the API invoker, a Generic Public Subscription Identifier (GPSI) of the API invoker, an Application layer ID of the API invoker, an AKMA key identifier (A-KID) of the API invoker, a Bootstrapping Transaction Identifier (B-TID) of the API invoker, or a Subscription Concealed Identifier (SUCI) of the API invoker.

A second type is an Application Function ID or an Application ID.

A third type is an Application Function Group ID or an Application Group ID.

The identifier of the expected service API refers to an identifier of an API that is expected by the UE to serve the API invoker.

The identifier of the service that the API invoker is allowed to request may be an identifier of a service that the API invoker can request the target resource owner to authorize. The service that can be requested by the API invoker does not exceed a service range that can be provided by the UE.

The identifier of the service operation that the API invoker is allowed to request may be an identifier of a service operation that the API invoker can request the target resource owner to authorize. The service operation that can be requested by the API invoker does not exceed a service operation range that can be provided by the UE.

The identifier of the target resource may identify location information, Quality of Service (QoS) information, and the like of the target resource owner.

As the UE serves as the target resource owner, the identifier of the target resource owner may be a terminal identifier of the UE, including but not limited to an IMPI, a GPSI, an Application layer ID, an A-KID, a B-TID, or an SUCI of the UE.

A geographic area that the API invoker should be in when accessing the target resource refers to an area to which a geographic location at which the API invoker is authorized to access the target resource belongs.

The authorization expiration time point may refer to a cut-off time point for authorization, which is configured by the UE for the API invoker.

In step 102, a setting response message returned by the AMF is received.

In the embodiment of the present disclosure, the setting response message is used to notify the UE that the updated file information content has been synchronized to the UDM.

In an implementation, the UE may receive second NAS message based on a N1 interface returned by the AMF, where the second NAS message carries the setting response message.

In the foregoing embodiment, after generating or updating the authorization configuration file, the user equipment may send a setting request message to the AMF, so as to send updated file information content to the AMF. The AMF may synchronize the updated file information content to the UDM. Thus, the CAPIF function that subscribes to the authorization configuration file can obtain a latest authorization configuration file in time from the UDM, so as to enable user authorization when the API invoker requests for the authorization, which has high availability.

The following describes, from an AMF side, an application program interface API invoking method provided in the present disclosure.

An embodiment of the present disclosure provides an API invoking method. Referring to FIG. 2, FIG. 2 is a flowchart of an API invoking method according to an embodiment, which may be performed by an AMF, and the method may include the following steps.

In step 201, a setting request message sent by a user equipment UE is received.

In the embodiment of the present disclosure, the setting request message is used to request to synchronize updated file information content in an authorization configuration file of the UE to a Unified Data Management (UDM). The authorization configuration file is used to authorize other UEs or Application Functions AFs to obtain, modify, or set a target resource of the UE.

In an implementation, the AMF may receive a first NAS message that is sent by the UE and is based on a N1 interface.

In an implementation, the authorization configuration file includes at least one of: a token type that needs to be authorized to the API invoker; an identifier of the API invoker; an identifier of an expected service API; an identifier of a service that the API invoker is allowed to request; an identifier of a service operation that the API invoker is allowed to request; an identifier of the target resource that the API invoker is allowed to request; an identifier of a target resource owner; a geographical area which the API invoker should be in when accessing the target resource; and an authorization expiration time point.

The token type that needs to be authorized to the API invoker includes but is not limited to a refresh token and an access token.

The identifier of the API invoker may include but is not limited to the following three types.

A first type is a terminal identifier of the API invoker, including but not limited to an IP Multimedia Private Identity (IMPI) of the API invoker, a Generic Public Subscription Identifier (GPSI) of the API invoker, an Application layer ID of the API invoker, an AKMA key identifier (A-KID) of the API invoker, a Bootstrapping Transaction Identifier (B-TID) of the API invoker, or a Subscription Concealed Identifier (SUCI) of the API invoker.

A second type is an Application Function ID or an Application ID.

A third type is an Application Function Group ID or an Application Group ID.

The identifier of the expected service API refers to an identifier of an API that is expected by the UE to serve the API invoker.

The identifier of the service that the API invoker is allowed to request may be an identifier of a service that the API invoker is allowed to request the target resource owner to authorize. The service that can be requested by the API invoker does not exceed a service range that can be provided by the UE.

The identifier of the service operation that the API invoker is allowed to request may be an identifier of a service operation that the API invoker is allowed to request the target resource owner to authorize. The service operation that can be requested by the API invoker does not exceed a service operation range that can be provided by the UE.

The identifier of the target resource may identify location information, Quality of Service (QoS) information, and the like of the target resource owner.

As the UE serves as the target resource owner, the identifier of the target resource owner may be a terminal identifier of the UE, including but not limited to an IMPI, a GPSI, an Application layer ID, an A-KID, a B-TID, or an SUCI of the UE.

A geographic area that the API invoker should be in when accessing the target resource refers to an area to which a geographic location at which the API invoker is authorized to access the target resource belongs.

The authorization expiration time point may refer to a cut-off time point for authorization, which is configured by the UE for the API invoker.

In step 202, the updated file information content is synchronized to the UDM.

In an implementation, the AMF may invoke a target service operation on the UDM, where the target service operation is used to synchronize the updated file information content to the UDM. In some examples, the updated file information content may be carried in the target service operation.

The target service operation may include a Nudm_ParameterProvision_Update service operation.

In step 203, a setting response message is sent to the UE.

In the embodiment of the present disclosure, the setting response message is used to notify the UE that the updated file information content has been synchronized to the UDM.

In an implementation, the AMF may transmit to the UE second NAS message based on a N1 interface, where the second NAS message carries the setting response message.

In the foregoing embodiment, the AMF may synchronize updated file information content to the UMD in time, which is easy to implement, achieves a purpose of enabling user authorization in an API invoking process, and has high availability.

The following describes, from a UDM side, an application program interface API invoking method provided in the present disclosure.

An embodiment of the present disclosure provides an application program interface API invoking method. Referring to FIG. 3, FIG. 3 is a flowchart of an application program interface API invoking method according to an embodiment, which may be performed by a UDM, and the method may include the following steps.

In step 301: updated file information content provided by an access and mobility management function AMF is obtained.

In the embodiment of the present disclosure, the updated file information content is from an authorization configuration file of a user equipment UE. The authorization configuration file is used to authorize other UEs or application functions AFs to obtain, modify, or set a target resource of the UE.

In an implementation, the authorization configuration file includes at least one of: a token type that needs to be authorized to the API invoker; an identifier of the API invoker; an identifier of an expected service API; an identifier of a service that the API invoker is allowed to request; an identifier of a service operation that the API invoker is allowed to request; an identifier of the target resource that the API invoker is allowed to request; an identifier of a target resource owner; a geographical area which the API invoker should be in when accessing the target resource; and an authorization expiration time point.

The token type that needs to be authorized to the API invoker includes but is not limited to a refresh token and an access token.

The identifier of the API invoker may include but is not limited to the following three types.

A first type is a terminal identifier of the API invoker, including but not limited to an IP Multimedia Private Identity (IMPI) of the API invoker, a Generic Public Subscription Identifier (GPSI) of the API invoker, an Application layer ID of the API invoker, an AKMA key identifier (A-KID) of the API invoker, a Bootstrapping Transaction Identifier (B-TID) of the API invoker, or a Subscription Concealed Identifier (SUCI) of the API invoker.

A second type is an Application Function ID or an Application ID.

A third type is an Application Function Group ID or an Application Group ID.

The identifier of the expected service API refers to an identifier of an API that is expected by the UE to serve the API invoker.

The identifier of the service that the API invoker is allowed to request may be an identifier of a service that the API invoker is allowed to request the target resource owner to authorize. The service that can be requested by the API invoker does not exceed a service range that can be provided by the UE.

The identifier of the service operation that the API invoker is allowed to request may be an identifier of a service operation that the API invoker is allowed to request the target resource owner to authorize. The service operation that can be requested by the API invoker does not exceed a service operation range that can be provided by the UE.

The identifier of the target resource may identify location information, Quality of Service (QoS) information, and the like of the target resource owner.

As the UE serves as the target resource owner, the identifier of the target resource owner may be a terminal identifier of the UE, including but not limited to an IMPI, a GPSI, an Application layer ID, an A-KID, a B-TID, or an SUCI of the UE.

A geographic area that the API invoker should be in when accessing the target resource refers to an area to which a geographic location at which the API invoker is authorized to access the target resource belongs.

The authorization expiration time point may refer to a cut-off time point for authorization, which is configured by the UE for the API invoker.

In step 302, an updated authorization configuration file is determined based on the updated file information content.

In an implementation, the UDM may store or update the authorization configuration file on a Unified Data Repository (UDR) function, to determine the updated authorization configuration file.

Specifically, the UDM may invoke a Nudr_DM_Update service operation, to store or update the authorization configuration file on the UDR.

In step 303, the updated authorization configuration file is sent to a Common API Framework for 3GPP Northbound APIs (CAPIF) function that subscribes to the authorization configuration file.

In the embodiment of the present disclosure, the UDM may pre-receive a subscription request message sent by the CAPIF function, where the subscription request message is used to request to subscribe to the authorization configuration file corresponding to the UE. Correspondingly, when determining to accept the subscription request of the CAPIF function, the UDM sends the authorization configuration file corresponding to the UE to the CAPIF function after obtaining the authorization configuration file.

In addition, after determining the updated authorization configuration file, the UDM may send the updated authorization configuration file to the CAPIF function that subscribes to the authorization configuration file.

In the embodiment of the present disclosure, the CAPIF function which subscribes to the authorization configuration file includes but is not limited to a CAPIF authentication authorization function and an API Exposure Function (AEF). Specifically, the CAPIF authentication authorization function may include but is not limited to a CAPIF core function (CCF) or an authorization function. Or the CAPIF authentication authorization function may be implemented by network functions deployed by an operator, and includes but is not limited to a nNEF.

In the foregoing embodiment, the UDM may notify the CAPIF function that subscribes to the authorization configuration file in time, so that the CAPIF function enables user authorization when the API invoker requests to obtain the authorization, which has high availability.

The following describes, from an API invoker side, an application program interface API invoking method provided in the present disclosure.

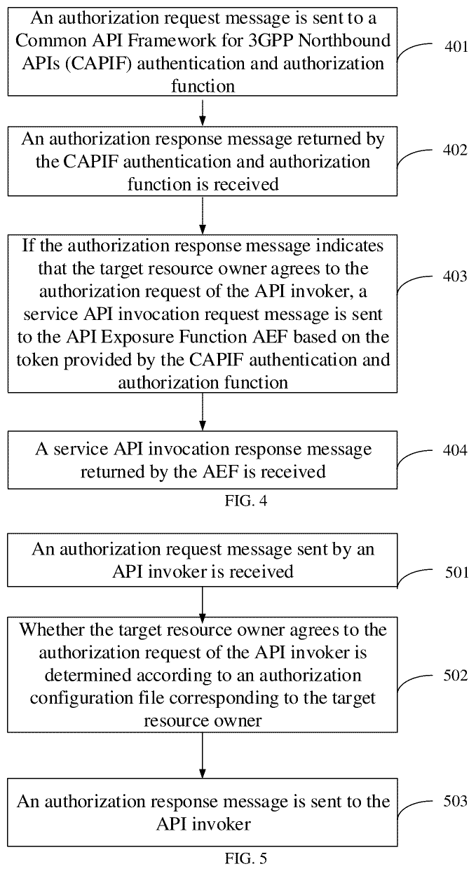

An embodiment of the present disclosure provides an application program interface API invoking method. Referring to FIG. 4, FIG. 4 is a flowchart of an application program interface API invoking method according to an embodiment, which may be performed by an API invoker, where the API invoker may be other UE or AF different from the target resource owner, and the method may include the following steps.

In step 401, an authorization request message is sent to a Common API Framework for 3GPP Northbound APIs (CAPIF) authentication and authorization function.

In the embodiment of the present disclosure, the CAPIF authentication and authorization function may include but is not limited to a CCF or an authorization function. Or, the CAPIF authentication and authorization function may be implemented by network functions deployed by an operator, including but not limited to an NEF. The authorization request message is used to request authorization of a target resource.

In an example, the authorization request message includes at least one of: an identifier of the API invoker; an identifier of a service API requested by the API invoker; an identifier of a service requested by the API invoker; an identifier of a service operation requested by the API invoker; an identifier of a target resource requested by the API invoker; or an identifier of a target resource owner.

The identifier of the API invoker may include but is not limited to the following three types.

A first type is a terminal identifier of the API invoker, includes but is not limited to an IP Multimedia Private Identity (IMPI) of the API invoker, a Generic Public Subscription Identifier (GPSI) of the API invoker, an Application layer ID of the API invoker, an AKMA key identifier (A-KID) of the API invoker, a Bootstrapping Transaction Identifier (B-TID) of the API invoker, or a Subscription Concealed Identifier (SUCI) of the API invoker.

A second type is an Application Function ID or an Application ID.

A third type is an Application Function Group ID or an Application Group ID.

The identifier of the target resource may identify location information, QoS information, and the like of the target resource owner.

The identifier of the service API requested by the API invoker may refer to an identifier of an API that the API invoker request the target resource owner to authorize.

The identifier of the service requested by the API invoker may refer to an identifier of a service that the API invoker request the target resource owner to authorize.

The identifier of the service operation requested by the API invoker may refer to an identifier of a service operation that the API invoker request the target resource owner to authorize.

The UE in the present disclosure is the target resource owner. Correspondingly, the identifier of the target resource owner may be a terminal identifier of the UE, including but not limited to an IMPI, a GPSI, an Application layer ID, an A-KID, a B-TID, or a SUCI of the UE.

In step 402, an authorization response message returned by the CAPIF authentication and authorization function is received.

The authorization response message is used to indicate whether the target resource owner agrees to the authorization request of the API invoker.

In an example, the authorization response message is used to indicate at least one of: a token type that the UE needs to obtain; whether the UE agrees to provide the specified authorization for the API invoker; the UE permanently agrees to provide the specified authorization for the API invoker; the UE permanently disagrees to provide the specified authorization for the API invoker; the API invoker needs to request new authorization each time accessing the target resource; the UE agrees to provide the specified authorization for the API invoker according to an authorization condition; or the UE disagrees to provide the specified authorization for the API invoker according to an authorization condition.

The token type includes, but is not limited to, a refresh token and an access token.

The authorization condition includes, but is not limited to, the API invoker being in a specified geographic area.

For example, it is agreed that the specified authorization is provided for the API invoker when the API invoker is located within the specified geographic area, or it is not agreed that the specified authorization is provided for the API invoker when the API invoker is located within the specified geographic area.

The foregoing description is merely an example, and other content indicated by the authorization response message should belong to the protection scope of the present disclosure.

In an example, the authorization response message may directly carry a token, where the token is used to obtain, modify, or set the target resource.

In another example, the authorization response message carries an authorization code. The API invoker may send, to the CAPIF authentication and authorization function, a first token request message that requests to obtain the token, where the first token request message carries the authorization code. Further, the CAPIF authentication and authorization function may send a token response message carrying the token to the API invoker based on the authorization code.

In an example, the token includes but is not limited to at least one of: a token type; an identifier of the CAPIF authentication and authorization function; an identifier of the API invoker; an identifier of an expected service API; an identifier of a service requested by the API invoker; an identifier of a service operation requested by the API invoker; an identifier of the target resource; an identifier of a target resource owner; a geographical area in which the API invoker accesses the target resource; an identifier of the AEF; and a validity expiration time point of the token.

The identifier of the CAPIF authentication and authorization function includes but is not limited to the following three types.

A first type is domain information, including but not limited to a Fully Qualified Domain Name (FQDN) of the CAPIF authentication and authorization function, and an address of the CAPIF authentication and authorization function, where the address of the CAPIF authentication and authorization function includes but is not limited to an Internet Protocol (IP) address of the CAPIF authentication and authorization function.

A second type is a Network Function ID or a Network function instance ID or NF instance ID of the CAPIF authentication and authorization function.

A third type is a Network Function Set ID of the CAPIF authentication and authorization function, and etc.

The identifier of the API invoker may include but is not limited to the following three types.

A first type is a terminal identifier of the API invoker, including but not limited to an IP Multimedia Private Identity (IMPI) of the API invoker, a Generic Public Subscription Identifier (GPSI) of the API invoker, an Application layer ID of the API invoker, an AKMA key identifier (A-KID) of the API invoker, a Bootstrapping Transaction Identifier (B-TID) of the API invoker, or a Subscription Concealed Identifier (SUCI) of the API invoker.

A second type is an Application Function ID or an Application ID.

A third type is an Application Function Group ID or an Application Group ID.

The UE is the target resource owner. Correspondingly, the identifier of the target resource owner may be a terminal identifier of the UE, including but not limited to an IMPI, a GPSI, an Application layer ID, an A-KID, a B-TID, or a SUCI of the UE.

The identifier of the expected service API may refer to an identifier of an API that is expected by the CAPIF authentication and authorization function to serve the API invoker.

The identifier of the service requested by the API invoker may be an identifier of a service that the API invoker request the target resource owner to authorize.

The identifier of the service operation requested by the API invoker may be an identifier of a service operation that the API invoker request the target resource owner to authorize.

The identifier of the AEF includes but is not limited to the following three types.

A first type is domain information of the AEF including, but is not limited to, an FQDN and an IP address of the AEF.

A second type is a Network Function instance ID or NF instance ID or a Network Function ID of the AEF.

A third type is a Network Function Set ID.

In step 403, if the authorization response message indicates that the target resource owner agrees to the authorization request of the API invoker, a service API invocation request message is sent to the API Exposure Function AEF based on the token provided by the CAPIF authentication and authorization function.

In this embodiment of the present disclosure, the API invoker may determine, based on local configuration information or the identifier of the API invoker in the token, the AEF to which the service API invocation request message is sent. Further, the API invoker may send the service API invocation request message to the AEF.

In an embodiment of the present disclosure, the service API invocation request message includes at least one of: the identifier of the API invoker; the identifier of the target resource owner; the identifier of the target resource; the identifier of the service API requested by the API invoker; the identifier of the service requested by the API invoker; the identifier of the service operation requested by the API invoker; and a token.

The identifier of the API invoker may include but is not limited to the following three types.

A first type is a terminal identifier of the API invoker, including but not limited to an IP Multimedia Private Identity (IMPI) of the API invoker, a Generic Public Subscription Identifier (GPSI) of the API invoker, an Application layer ID of the API invoker, an AKMA key identifier (A-KID) of the API invoker, a Bootstrapping Transaction Identifier (B-TID) of the API invoker, or a Subscription Concealed Identifier (SUCI) of the API invoker.

A second type is an Application Function ID or an Application ID.

A third type is an Application Function Group ID or an Application Group ID.

As the UE serves as the target resource owner, the identifier of the target resource owner may be a terminal identifier of the UE, including but not limited to an IMPI, a GPSI, an Application layer ID, an A-KID, a B-TID, or an SUCI of the UE.

The identifier of the target resource may identify location information, QoS information, and the like of the target resource owner.

The identifier of the service API requested by the API invoker may refer to an identifier of a service API that the API invoker request the target resource owner to authorize.

The identifier of the service requested by the API invoker may refer to an identifier of a service that the API invoker request the target resource owner to authorize.

The identifier of the service operation requested by the API invoker may refer to an identifier of a service operation that the API invoker request the target resource owner to authorize.

In an example, the token includes but is not limited to at least one of: a token type; an identifier of the CAPIF authentication and authorization function; an identifier of the API invoker; an identifier of an expected service API; an identifier of a service requested by the API invoker; an identifier of a service operation requested by the API invoker; an identifier of the target resource; an identifier of a target resource owner; a geographical area in which the API invoker accesses the target resource; an identifier of the AEF; or a validity expiration time point of the token.

A specific information content of the token has been described in the foregoing embodiment, and details are not described herein again.

In an implementation, if the CAPIF authentication and authorization function provides the API invoker with a first token of which a token type is a refresh token, the API invoker sends, to the CAPIF authentication and authorization function when needing to obtain the target resource, a second token request message carrying the first token. The second token request message is used to request a second token of which a token type is an access token.

Further, the API invoker may receive the second token of which the token type is the access token and that is returned by the CAPIF authentication and authorization function. And the API invoker sends the service API invocation request message to the AEF based on the second token.

In another implementation, if the CAPIF authentication and authorization function provides the second token of which the token type is the access token, the API invoker may directly send the service API invocation request message to the AEF based on the second token.

In step 404, a service API invocation response message returned by the AEF is received.

When the AEF determines that a verification result for the token is valid and information in the service API invocation request message matches information in the token, the AEF may send the service API invocation response message to the API invoker, where the service API invocation response message carries the target resource requested by the API invoker.

In the foregoing embodiment, the API invoker may obtain the target resource of the target resource owner based on user authorization, where the API invoker is the target resource owner, so that user authorization is enabled in an API invoking process, which has high availability.

In some embodiments, when determining to obtain the target resource, the API invoker may first determine whether an authorized token or authorization code exists locally.

In an implementation, when the API invoker locally has an authorized token and the token is the second token, the API invoker may directly send a service API invocation request message to the AEF, and receive a service API invocation response message returned by the AEF.

The specific implementation is similar to the foregoing steps 403 and 404, and details are not described herein again.

In another implementation, when the API invoker has the authorization code locally, the API invoker may send, to the CAPIF authentication and authorization function, the first token request message that requests to obtain the token, where the first token request message carries the authorization code. Further, the API invoker may receive the token response message that carries the token and that is returned by the CAPIF authentication and authorization function.

When the CAPIF authentication and authorization function provides the first token of which the token type is the refresh token to the API invoker through the token response message, the API invoker sends the second token request message to the CAPIF authentication and authorization function when needing to obtain the target resource. Subsequently the API invoker sends the service API invocation request message to the AEF based on the second token, and receives the service API invocation response message returned by the AEF.

If the CAPIF authentication and authorization function provides the second token of which the token type is the access token to the API invoker through the token response message, the API invoker sends the service API invocation request message to the AEF based on the second token, and receives the service API invocation response message returned by the AEF.

In the foregoing embodiment, the API invoker may directly obtain the target resource from the AEF in the foregoing manner, or obtain the target resource from the AEF after obtaining the token from the CAPIF, without repeatedly requesting authorization of the target resource owner, thereby saving signaling resources, which has high availability.

In some embodiments, the API invoker may perform mutual identity authentication with the CAPIF authentication and authorization function in advance. The CAPIF authentication and authorization function may include but is not limited to a CAPIF core function or an authorization function. Or the CAPIF authentication and authorization function may be implemented by network functions deployed by an operator, and includes but is not limited to a NEF.

In an implementation, the API invoker may perform the mutual identity authentication with the CAPIF authentication and authorization function based on a certificate.

In another implementation, the API invoker may perform the mutual identity authentication with the CAPIF authentication and authorization function based on the General Bootstrapping Architecture GBA.

In another implementation, the API invoker may perform the mutual identity authentication with the CAPIF authentication and authorization function based on an AKMA mechanism.

In an example, the CAPIF authentication and authorization function is the CAPIF core function. The API invoker may perform identity authentication on the CAPIF core function based on a certificate, and the CAPIF core function may perform identity authentication on the API invoker based on a GBA mechanism, an AKMA mechanism, or a certificate.

The CAPIF core function may generate a certificate for the API invoker after the API invoker subscribes online.

In another example, the CAPIF authentication and authorization function is the authorization function, the API invoker may perform identity authentication on the authorization function based on a certificate, and the authorization function may perform identity authentication on the API invoker based on a GBA mechanism, an AKMA mechanism, or a certificate.

The certificate may be allocated by the CAPIF core function.

In the embodiment of the present disclosure, the API invoker may establish a first secure connection with the CAPIF authentication and authorization function through TLS after the mutual identity authentication with the CAPIF authentication and authorization function succeeds.

Further, the API invoker may send the authorization request message to the CAPIF authentication and authorization function through the first secure connection.

The API invoker may receive, through the first secure connection, the authorization response message sent by the CAPIF authentication and authorization function.

In the foregoing embodiment, the API invoker may perform the mutual identity authentication with the CAPIF authentication and authorization function. After the identity authentication succeeds, the API invoker establish the first secure connection, thereby ensuring secure transmission of the authorization request message and the authorization response message, which has high availability.

In some embodiments, the API invoker may perform mutual identity authentication with the AEF in advance.

In an implementation, the API invoker may perform mutual identity authentication with the AEF based on the certificate.

In another implementation, the API invoker may perform mutual identity authentication with the AEF based on the GBA.

In another implementation, the API invoker may perform mutual identity authentication with the AEF based on the AKMA mechanism.

In an example, the API invoker may perform identity authentication on the AEF based on a certificate, and the AEF may perform identity authentication on the API invoker based on the GBA mechanism, the AKMA mechanism, or the certificate.

The certificate may be allocated by the CAPIF core function.

In the embodiment of the present disclosure, after the mutual identity authentication with the AEF succeeds, the API invoker may establish a second secure connection with the AEF through TLS.

Further, the API invoker sends the service API invocation request message carrying the token to the AEF through the second secure connection.

The API invoker may receive, through the second secure connection, the service API invocation response message returned by the AEF.

Certainly, the token is a second token, and a token type of the second token is an access token.

In the foregoing embodiment, the API invoker may perform mutual identity authentication with the AEF, and establish the second secure connection after the identity authentication succeeds, thereby ensuring secure transmission of the token and the target resource, which has high availability.

The following describes, from a CAPIF authentication and authorization function side, the application program interface API invoking method provided in the present disclosure.

An embodiment of the present disclosure provides an API invoking method. Referring to FIG. 5, FIG. 5 is a flowchart of an API invoking method according to an embodiment, which may be performed by a CAPIF authentication and authorization function. The CAPIF authentication and authorization function may include but is not limited to a CAPIF core function and an authorization function, or the CAPIF authentication and authorization function may be implemented by network functions deployed by an operator, which is not limited in the present disclosure, and the method may include the following steps.

In step 501, an authorization request message sent by an API invoker is received.

In an embodiment of the present disclosure, the authorization request message is used to request authorization of the target resource. The API invoker may be another UE or AF different from the target resource owner. The target resource includes but is not limited to location information, QoS information, and the like of the UE serving as the target resource owner.

In an implementation, the authorization configuration file includes at least one of: a token type that needs to be authorized to the API invoker; an identifier of the API invoker; an identifier of an expected service API; an identifier of a service that the API invoker is allowed to request; an identifier of a service operation that the API invoker is allowed to request; an identifier of the target resource that the API invoker is allowed to request; an identifier of a target resource owner; a geographical area that the API invoker should be in when accessing the target resource; and an authorization expiration time point.

In an implementation, the authorization request message includes at least one of: an identifier of the API invoker; an identifier of a service API requested by the API invoker; an identifier of a service requested by the API invoker; an identifier of a service operation requested by the API invoker; an identifier of a target resource requested by the API invoker; or an identifier of a target resource owner.

In an implementation, the authorization configuration file includes at least one of: a token type that needs to be authorized to the API invoker; an identifier of the API invoker; an identifier of an expected service API; an identifier of a service that the API invoker is allowed to request; an identifier of a service operation that the API invoker is allowed to request; an identifier of the target resource that the API invoker is allowed to request; an identifier of a target resource owner; a geographical area that the API invoker should be in when accessing the target resource; and an authorization expiration time point.

The specific information content in the authorization request message and the authorization configuration file is the same as the information content described in the foregoing embodiment, and details are not described herein again.

In step 502, whether the target resource owner agrees to the authorization request of the API invoker is determined according to an authorization configuration file corresponding to the target resource owner.

In the embodiment of the present disclosure, when the authorization configuration file has been subscribed to, the CAPIF authentication and authorization function obtains the authorization configuration file or the updated authorization configuration file from the UDM. Therefore, whether the target resource owner agrees to the authorization request of the API invoker may be determined according to the latest authorization configuration file.

In step 503, an authorization response message is sent to the API invoker.

The authorization response message is used to indicate whether the target resource owner agrees to the authorization request of the API invoker.

In an example, the authorization response message is used to indicate at least one of: a token type that the UE needs to obtain; whether the UE agrees to provide the specified authorization for the API invoker; the UE permanently agrees to provide the specified authorization for the API invoker; the UE permanently disagrees to provide the specified authorization for the API invoker; the API invoker needs to request new authorization each time accessing the target resource; the UE agrees to provide the specified authorization for the API invoker according to an authorization condition; or the UE disagrees to provide the specified authorization for the API invoker according to an authorization condition.

The token type includes, but is not limited to, a refresh token and an access token.

The authorization conditions include, but are not limited to, the API invoker being in a specified geographic area.

For example, the API invoker agrees to provide the specified authorization for the API invoker when the API invoker is located within the specified geographic area, or the API invoker does not agree to provide the specified authorization for the API invoker when the API invoker is located within the specified geographic area.

The foregoing description is merely an example, and other content indicated by the authorization response message should belong to the protection scope of the present disclosure.

In an implementation, if the target resource owner agrees to the authorization request of the API invoker, the authorization response message may directly carry a token, where the token is used to authorize the API invoker to obtain, modify, or set the target resource.

In another implementation, if the target resource owner agrees to the authorization request of the API invoker, the authorization response message may carry an authorization code. Further, the CAPIF authentication and authorization function may receive a first token request message that is sent by the API invoker and that requests to obtain a token. The first token request message carries the authorization code, and the token is a token used to obtain, modify, or set the target resource. After verifying the authorization code successfully, the CAPIF authentication and authorization function sends a token response message carrying the token to the API invoker.

In an example, the token includes but is not limited to at least one of: a token type; an identifier of the CAPIF authentication and authorization function; an identifier of the API invoker; an identifier of an expected service API; an identifier of a service requested by the API invoker; an identifier of a service operation requested by the API invoker; an identifier of the target resource; an identifier of a target resource owner; a geographical area in which the API invoker accesses the target resource; an identifier of the AEF; or a validity expiration time point of the token.

A specific information content included in the token has been described in the foregoing embodiment, and details are not described herein again.

In the embodiment of the present disclosure, if it is determined according to the authorization configuration file that the target resource owner agrees to the authorization request of the API invoker, the CAPIF authentication and authorization function may generate a token constrained by the authorization configuration file for the API invoker. The generated token type is an access token or a refresh token.

In the embodiment of the present disclosure, if it is determined, according to the configuration authorization file corresponding to the target resource owner, that the target resource owner agrees to the authorization request of the API invoker, and the CAPIF authentication and authorization function provides, for the API invoker, a first token of which a token type is a refresh token, for example, the CAPIF authentication and authorization function provides the first token for the API invoker through an authorization response message or a token response message, the CAPIF authentication and authorization function may receive a second token request message sent when the API invoker needs to obtain the target resource. The second token request message is used to request a second token of which a token type is an access token, and the second token request message carries the first token.

In the embodiment of the present disclosure, the CAPIF authentication and authorization function may send the second token of which a token type is the access token to the API invoker after verifying that the first token is valid based on the second token request message. The API invoker may send a service API invocation request message to the AEF based on the second token.

If the target resource owner agrees to the authorization request of the API invoker, and the CAPIF authentication and authorization function provides, for the API invoker, a second token of which a token type is an access token, for example, the CAPIF authentication and authorization function provides the second token for the API invoker through an authorization response message or a token response message, the API invoker may directly send a service API invocation request message to the AEF based on the second token.

In the foregoing embodiment, the CAPIF authentication and authorization function may obtain the latest authorization configuration file from the UDM, and after receiving the authorization request message of the API invoker, determine, based on the latest authorization configuration file, whether the UE agrees to provide authorization, and then send the authorization response message to the API invoker, thereby achieving a purpose of enabling user authorization in an API invoking process, which has high availability.

In some embodiments, the CAPIF authentication and authorization function may perform mutual identity authentication with the API invoker in advance. The CAPIF authentication and authorization function may include but is not limited to a CAPIF core function and an authorization function, or the CAPIF authentication and authorization function may be implemented by network functions deployed by an operator, including but not limited to an NEF. The API invoker may be UE or AF, where the UE is one UE different from the target resource owner.

In an implementation, the CAPIF authentication and authorization function may perform mutual identity authentication with the API invoker based on a certificate.

In another implementation, the CAPIF authentication and authorization function may perform mutual identity authentication with the API invoker based on a General Bootstrapping Architecture GBA.

In another implementation, the CAPIF authentication and authorization function may perform mutual identity authentication with the API invoker based on an AKMA mechanism.

In an example, the CAPIF authentication and authorization function is a CAPIF core function, the API invoker may perform identity authentication on the CAPIF core function based on a certificate. The CAPIF core function may perform identity authentication on the API invoker based on a GBA mechanism, an AKMA mechanism, or a certificate.

The CAPIF core function may generate a certificate for the API invoker after the API invoker subscribes online. That is, the certificate of the UE is allocated to the UE by the CAPIF authentication and authorization function.

In another example, the CAPIF authentication and authorization function is an authorization function, the API invoker may perform identity authentication on the authorization function based on a certificate, and the authorization function may perform identity authentication on the API invoker based on a GBA mechanism, an AKMA mechanism, or a certificate.

The certificate may be allocated by the CAPIF core function.

In the embodiment of the present disclosure, the API invoker may establish a first secure connection with the CAPIF authentication and authorization function through TLS after the mutual identity authentication with the CAPIF authentication and authorization function succeeds.

Further, the CAPIF authentication and authorization function may receive an authorization request message sent by the API invoker through the first secure connection.

The CAPIF authentication and authorization function may send an authorization response message to the API invoker through the first secure connection.

In the foregoing embodiment, the CAPIF authentication and authorization function may perform mutual identity authentication with the API invoker, and establish the first secure connection after the identity authentication succeeds, thereby ensuring secure transmission of the authorization request message and the authorization response message, which has high availability.

The following describes, from an AEF side, an application program interface API invoking method provided in the present disclosure.

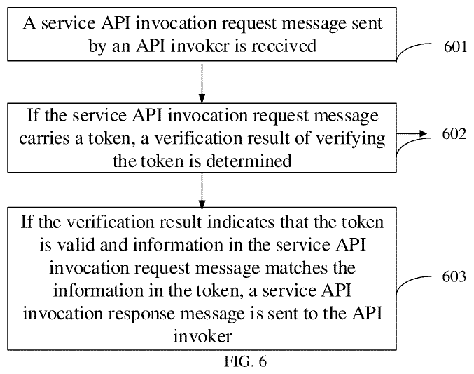

An embodiment of the present disclosure provides an API invoking method. Referring to FIG. 6, FIG. 6 is a flowchart of an API invoking method according to an embodiment. The method may be performed by AEF, and includes the following steps.

In step 601, a service API invocation request message sent by an API invoker is received.

In the embodiments of the present disclosure, the API invoker may be another UE different from the UE or AF.

In an example, the service API invocation request message includes at least one of: the identifier of the API invoker; the identifier of the target resource owner; the identifier of the target resource; the identifier of the service API requested by the API invoker; the identifier of the service requested by the API invoker; the identifier of the service operation requested by the API invoker; or a token.

The token is used to authorize the API invoker to obtain, modify or set the target resource of the target resource owner.

A specific information content about the service API invocation request message has been described in the foregoing embodiment, and details are not described herein again.

In step 602, if the service API invocation request message carries a token, a verification result of verifying the token is determined.

The token is used to authorize the API invoker to obtain the target resource of the target resource owner. Information included in the token has been described in the foregoing embodiment, and details are not described herein again.

In an example, the AEF may verify integrity of the token based on a public key of a CAPIF authentication and authorization function, to determine the verification result.

In an example, the AEF may send the token to a CAPIF authentication and authorization function, and receive a verification result of verifying integrity of the token, returned by the CAPIF authentication and authorization function.

It should be noted herein that when the service API invocation request message carries the second token of which a token type is the access token, the AEF determines a verification result of verifying the second token.

In step 603, if the verification result indicates that the token is valid and information in the service API invocation request message matches the information in the token, a service API invocation response message is sent to the API invoker.

In an example, the information in the service API invocation request message includes an identifier of the API invoker; an identifier of the target resource owner; an identifier of the target resource; an identifier of a service API requested by the API invoker; an identifier of a service requested by the API invoker; and an identifier of a service operation requested by the API invoker.

In an example, the token includes but is not limited to at least one of: a token type; an identifier of the CAPIF authentication and authorization function; an identifier of the API invoker; an identifier of an expected service API; an identifier of a service requested by the API invoker; an identifier of a service operation requested by the API invoker; an identifier of the target resource; an identifier of a target resource owner; a geographical area in which the API invoker accesses the target resource; an identifier of the AEF; or a validity expiration time point of the token.

The AEF needs to determine whether the information in the service API invocation request message matches information in the token. And when the verification result indicates that the token is valid, and the information in the service API invocation request message matches the information in the token, that is, when the service API request initiated by the API invoker is within a permission range of the token, the AEF sends a service API invocation response message to the API invoker. The service API invocation response message carries the target resource.

Certainly, the AEF needs to pre-authenticate first identity information of the API invoker. And on basis of completing identity authentication, the AEF determines a verification result of verifying the token and whether the information in the service API invocation request message matches information included in the token.

The first identity information may include but is not limited to the identifier of the API invoker. In an example, the identifier of the API invoker may include an A-KID of the API invoker, a B-TID of the API invoker, an SUPI of the API invoker, and a GPSI of the API invoker.

In the foregoing embodiment, after receiving the API invoking request message sent by the API invoker, if the service API invocation request message carries the token, the AEF may verify the token. And after a verification result indicates that the token is valid, the AEF sends a service API invocation response message to the API invoker, where the service API invocation response message carries the target resource. This achieves the purpose of enabling the user authorization to provide the target resource for the API invoker in the API invoking process and has high availability.

In some embodiments, if the verification result indicates that the token is invalid, the AEF may terminate the API invoking process.

In the foregoing embodiment, if the AEF determines that the token is invalid, the API invoking process may be terminated in time, to ensure security and reliability of the API invoking process.

In some embodiments, if the service API invocation request message does not carry the token, the AEF may send a message for rejecting the invoking of the service API to the API invoker.

In some examples, the message for rejecting the invoking of the service API may carry a reject reason, and the reject reason may be that no token is carried.

In the foregoing embodiment, if the service API invocation request message does not carry the token, the AEF may reject the request of the API invoker, which also ensures security and reliability of the API invoking process.

In some embodiments, in addition to checking the integrity of the token, the AEF needs to pre-authenticate first identity information of the API invoker. The first identity information includes but is not limited to an identifier of the API invoker, and in some examples, the identifier of the API invoker may include an A-KID of the API invoker, a B-TID of the API invoker, an SUPI of the API invoker, and a GPSI of the API invoker.

Further, if the authenticated first identity information is same as the identifier of the API invoker in the certificate and it is determined that the verification result of the token is valid, but the information in the service API invocation request message does not match the information in the token, that is, the service API invocation request initiated by the API invoker exceeds a permission range of the token, the AEF may send the message for rejecting the invoking of the service API to the API invoker.

If the authenticated first identity information is the same as the identifier of the API invoker in the certificate and it is determined that the verification result for the token is valid, and the information in the service API invocation request message matches the information in the token, that is, the service API invocation request initiated by the API invoker does not exceed the permission range of the token, the AEF may send the service API invocation response message to the API invoker.

In the foregoing embodiment, the AEF may reject or agree to the service API invocation request initiated by the API invoker when the foregoing condition is met, thereby ensuring security and reliability of the API invoking process.

In some embodiments, the AEF may perform mutual identity authentication with the API invoker in advance.

In an implementation, the AEF may perform mutual identity authentication with the API invoker based on the certificate.

In another implementation, the AEF may perform mutual identity authentication with the API invoker based on the GBA.

In another implementation, the AEF may perform mutual identity authentication with the API invoker based on the AKMA mechanism.

In an example, the API invoker may perform identity authentication on the AEF based on a certificate, and the AEF may perform identity authentication on the API invoker based on the GBA mechanism, the AKMA mechanism, or the certificate.

The certificate may be allocated by the CAPIF core function.

In the embodiment of the present disclosure, after performing mutual identity authentication with the API invoker, the AEF may establish a second secure connection with the API invoker through TLS.

Further, the AEF receives the service API invocation request message sent by the API invoker through the second secure connection.

The AEF may send the service API invocation response message to the API invoker through the second secure connection.

In the foregoing embodiment, the AEF may perform mutual identity authentication with the API invoker, and establish the second secure connection after the identity authentication succeeds, thereby ensuring secure transfer of the token and the target resource, which has high availability.

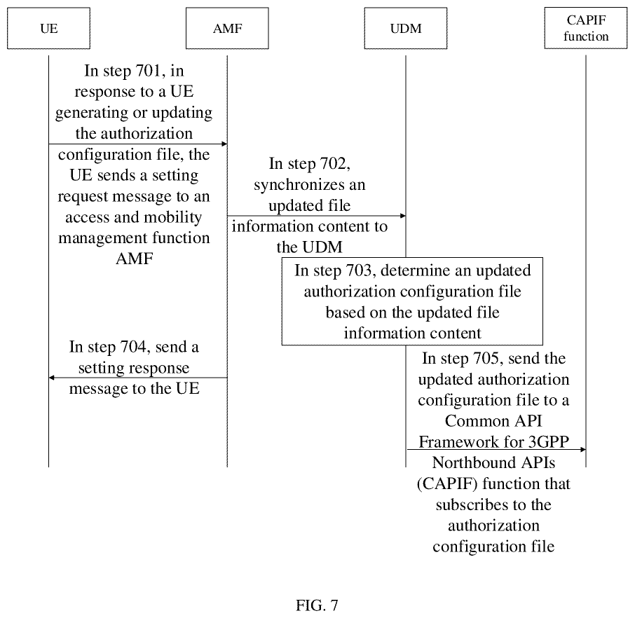

An embodiment of the present disclosure provides an API invoking method. Referring to FIG. 7, FIG. 7 is a flowchart of an API invoking method according to an embodiment, and the method may include the following steps.

In step 700 (not shown in FIG. 7), a CAPIF function may subscribe to a UDM notification message of an updated authorization configuration file.

The CAPIF function includes but is not limited to a CAPIF authentication and authorization function and an API Exposure Function (AEF). Specifically, the CAPIF authentication and authorization function may include but is not limited to a CAPIF core function (CCF) or an Authorization Function. Or the CAPIF authentication and authorization function may be implemented by network functions deployed by an operator, and includes but is not limited to a Network Exposure Function (NEF).

In step 701, in response to a UE generating or updating the authorization configuration file, the UE sends a setting request message to an access and mobility management function AMF.

In the embodiment of the present disclosure, the UE may send a setting request message to the AMF through a NG Radio Access Network (NG RAN) (not shown in FIG. 7).

In the embodiment of the present disclosure, the authorization configuration file is used to authorize other UEs or AFs to obtain, modify or set a target resource of the UE.

When the authorization configuration file has been generated or the generated authorization configuration file has been updated, the UE may send the setting request message to an access and mobility management function (AMF), where the setting request message is used to request to synchronize file information content updated in the authorization configuration file to the UDM.

In an implementation, the UE may send a first non-access stratum (NAS) message based on a N1 interface to the AMF.

In an implementation, the authorization configuration file includes at least one of: a token type that needs to be authorized to the API invoker; an identifier of the API invoker; an identifier of an expected service API; an identifier of a service that the API invoker is allowed to request; an identifier of a service operation that the API invoker is allowed to request; an identifier of the target resource that the API invoker is allowed to request; an identifier of a target resource owner; a geographical area which the API invoker should be in when accessing the target resource; and an authorization expiration time point.

A specific information content of the authorization configuration file has been described in the foregoing embodiment, and details are not described herein again.

In step 702, the AMF synchronizes an updated file information content to the UDM.

In an implementation, the AMF may invoke a target service operation from the UDM, where the target service operation is used to synchronize the updated file information content to the UDM. In some examples, the updated file information content can be carried in the target service operation.

The target service operation may be a Nudm_ParameterProvision_Update service operation.

In step 703, the UDM determines an updated authorization configuration file based on the updated file information content.

In an implementation, the UDM may store or update the authorization configuration file on a Unified Data Repository (UDR) function, to determine the updated authorization configuration file.

Specifically, the UDM may invoke a Nudr_DM_Update service operation, to store or update the authorization configuration file on the UDR.

In step 704, the AMF sends a setting response message to the UE.

In the embodiment of the present disclosure, the setting response message is used to notify the UE that the updated file information content has been synchronized to the UDM.

In an implementation, the AMF may send a second NAS message based on the N1 interface to the UE, where the second NAS message carries the setting response message.

In step 705, the UDM sends the updated authorization configuration file to a Common API Framework for 3GPP Northbound APIs (CAPIF) function that subscribes to the authorization configuration file.

Certainly, after subscribing to the authorization configuration file, the CAPIF function may cancel the subscription to the authorization configuration file as required, and the UDM no longer sends the UDM notification message to the CAPIF function having canceled the subscription.

In the foregoing embodiment, after generating or updating the authorization configuration file, the user equipment may send the setting request message to the AMF, so as to send the updated file information content to the AMF. And the AMF may synchronize the updated file information content to the UDM, so that the CAPIF function subscribing to the authorization configuration file can obtain a latest authorization configuration file in time from the UDM. When the API invoker requests to obtain authorization, user authorization is enabled, which has high availability.

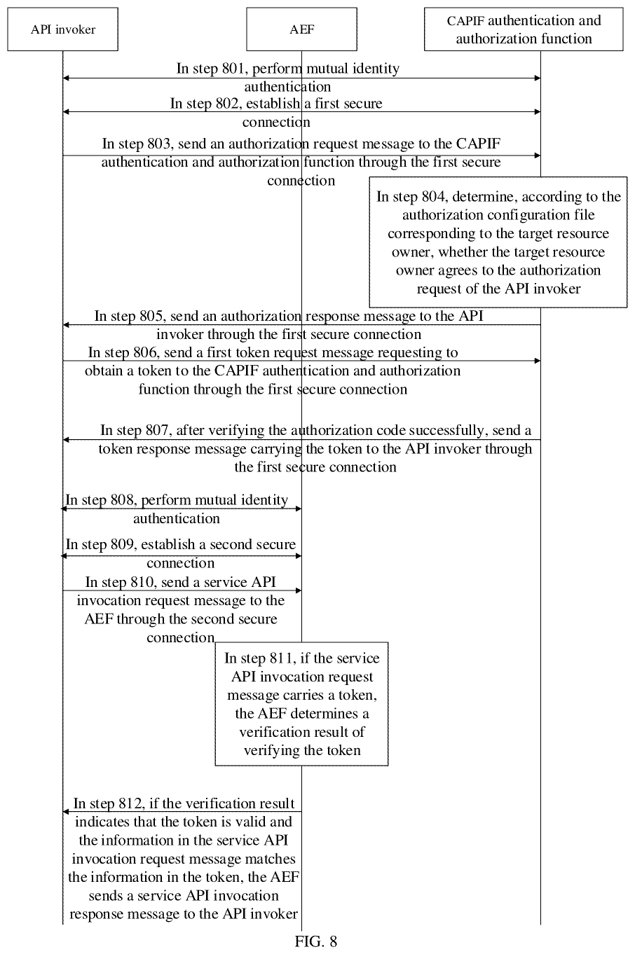

An embodiment of the present disclosure provides an API invoking method. Referring to FIG. 8, FIG. 8 is a flowchart of an API invoking method according to an embodiment. The method may include the following steps.

In step 801, an API invoker performs mutual identity authentication with a CAPIF authentication and authorization function.

In the embodiment of the present disclosure, the API invoker may be another UE different from a target resource owner, or the API invoker may be an AF.

The identity authentication method has been described on the API invoker side and the CAPIF authentication and authorization function side, so the steps will not be described herein.

In step 802, the API invoker establishes a first secure connection with the CAPIF authentication and authorization function.

In the embodiment of the present disclosure, the API invoker may establish the first secure connection with the CAPIF authentication and authorization function through TLS after the mutual identity authentication with the CAPIF authentication and authorization function succeeds.

In step 803, the API invoker sends an authorization request message to the CAPIF authentication and authorization function through the first secure connection.

The authorization request message is used to request authorization of the target resource.

In an example, the authorization request message includes at least one of: an identifier of the API invoker; an identifier of a service API requested by the API invoker; an identifier of a service requested by the API invoker; an identifier of a service operation requested by the API invoker; an identifier of a target resource requested by the API invoker; or an identifier of a target resource owner.

A specific information content of the authorization request message has been described in the foregoing embodiment, and details are not described herein again.

In step 804, the CAPIF authentication and authorization function determines, according to the authorization configuration file corresponding to the target resource owner, whether the target resource owner agrees to the authorization request of the API invoker.

In the embodiment of the present disclosure, when the authorization configuration file has been subscribed to, the CAPIF authentication and authorization function obtains the authorization configuration file or the updated authorization configuration file from the UDM. Therefore, whether the target resource owner agrees to the authorization request of the API invoker may be determined according to the latest authorization configuration file.

In step 805, the CAPIF authentication and authorization function sends an authorization response message to the API invoker through the first secure connection.

The authorization response message is used to indicate whether the target resource owner agrees to the authorization request of the API invoker.

In an example, the authorization response message is used to indicate at least one of: a token type that the UE needs to obtain; whether the UE agrees to provide the specified authorization for the API invoker; the UE permanently agrees to provide the specified authorization for the API invoker; the UE permanently disagrees to provide the specified authorization for the API invoker; the API invoker needs to request new authorization each time accessing the target resource; the UE agrees to provide the specified authorization for the API invoker according to an authorization condition; or the UE disagrees to provide the specified authorization for the API invoker according to an authorization condition.

A specific information content included in the authorization response message has been described in the foregoing embodiment, and details are not described herein again.

In the embodiment of the present disclosure, if the target resource owner agrees to the authorization request of the API invoker, the authorization response message carries an authorization code.

In step 806, the API invoker sends a first token request message requesting to obtain a token to the CAPIF authentication and authorization function through the first secure connection.

The first token request message carries the authorization code, and the token is a token used to obtain, modify, or set the target resource.

In an example, the token includes but is not limited to at least one of: a token type; an identifier of the CAPIF authentication and authorization function; an identifier of the API invoker; an identifier of an expected service API; an identifier of a service requested by the API invoker; an identifier of a service operation requested by the API invoker; an identifier of the target resource; an identifier of a target resource owner; a geographical area in which the API invoker accesses the target resource; an identifier of the AEF; or a validity expiration time point of the token.

The specific information content is not described again.

In step 807, after verifying the authorization code successfully, the CAPIF authentication and authorization function sends a token response message carrying the token to the API invoker through the first secure connection.

In the embodiment of the present disclosure, if the target resource owner agrees to the authorization request of the API invoker, and the CAPIF authentication and authorization function provides, for the API invoker, a first token of which a token type is a refresh token, for example, the CAPIF authentication and authorization function provides the first token for the API invoker through an authorization response message or a token response message, the CAPIF authentication and authorization function may receive a second token request message sent when the API invoker needs to obtain the target resource. The second token request message is used to request to obtain a second token of which a token type is an access token, and the second token request message carries the first token.

In the embodiment of the present disclosure, the CAPIF authentication and authorization function may send the second token of which the token type is the access token to the API invoker after verifying that the first token is valid based on the second token request message. The API invoker may send a service API invocation request message to the AEF based on the second token.

If the target resource owner agrees to the authorization request of the API invoker, and the CAPIF authentication and authorization function provides, for the API invoker, the second token of which the token type is the access token, for example, the CAPIF authentication and authorization function provides the second token for the API invoker through an authorization response message or a token response message, the API invoker may directly send a service API invocation request message to the AEF based on the second token.

In step 808, the API invoker performs mutual identity authentication with the AEF.

A specific authentication manner has been described in the foregoing embodiment, and details are not described herein again.

In step 809, the API invoker establishes a second secure connection with the AEF.

In step 810, the API invoker sends a service API invocation request message to the AEF through the second secure connection.

In an example, the service API invocation request message includes at least one of: an identifier of the API invoker; an identifier of a target resource owner; an identifier of the target resource; an identifier of a service API requested by the API invoker; an identifier of a service requested by the API invoker; an identifier of a service operation requested by the API invoker; or a token.

The token is used to authorize the API invoker to obtain, modify or set the target resource of the target resource owner.

A specific information content of the service API invocation request message has been described in the foregoing embodiment, and details are not described herein again.

In step 811, if the service API invocation request message carries a token, the AEF determines a verification result of verifying the token.

The token is used to authorize the API invoker to obtain the target resource of the target resource owner. The information included in the token has been described in the foregoing embodiment, and details are not described herein again.

In an example, the AEF may verify integrity of the token based on a public key of the CAPIF authentication and authorization function, to determine the verification result.

In an example, the AEF may send the token to the CAPIF authentication and authorization function, and receive the verification result of verifying integrity of the token, returned by the CAPIF authentication and authorization function.

It should be noted herein that when the service API invocation request message carries the second token of which the token type is the access token, the AEF determines the verification result of verifying the second token.

In step 812, if the verification result indicates that the token is valid and the information in the service API invocation request message matches the information in the token, the AEF sends a service API invocation response message to the API invoker.

The service API invocation response message carries the target resource.

In the above embodiment, the purpose of enabling user authorization in the API invoking process is achieved, which has high availability.

Corresponding to the foregoing embodiment of the application function implementation method, the present disclosure further provides embodiments of application function implementation apparatuses.

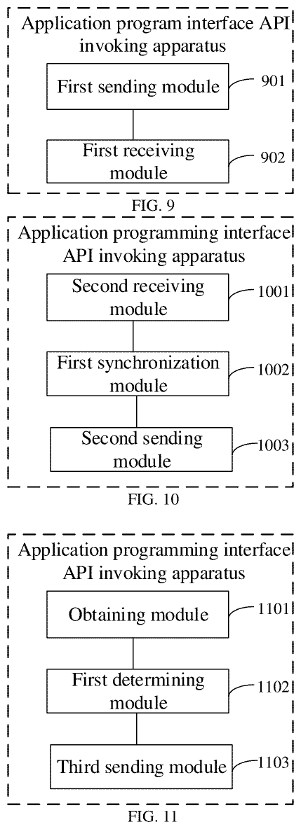

Referring to FIG. 9, FIG. 9 is a block diagram of an application program interface API invoking apparatus according to an example. The apparatus is applied to a user equipment (UE), including:
a first sending module 901, configured for sending a setting request message to an Access and Mobility Management Function (AMF) in response to the UE generating or updating an authorization configuration file, wherein the authorization configuration file is for authorizing other UEs or Application Function (AFs) to obtain, modify, or set a target resource of the UE, and the setting request message is for requesting to synchronize updated file information content in the authorization configuration file to a Unified Data Management (UDM); and
a first receiving module 902, configured for receiving a setting response message returned by the AMF, wherein the setting response message is for notifying the UE that the updated file information content has been synchronized to the UDM.

Referring to FIG. 10, FIG. 10 is a block diagram of an application programming interface API invoking apparatus according to an example. The apparatus is applied to an Access and Mobility Management Function (AMF), including:
a second receiving module 1001, configured for receiving a setting request message sent by a user equipment (UE), wherein the setting request message is for requesting to synchronize updated file information content in an authorization configuration file of the UE to a Unified Data Management (UDM), and the authorization configuration file is for authorizing other UEs or Application Functions (AFs) to obtain, modify, or set a target resource of the UE;
a first synchronization module 1002, configured for synchronizing the updated file information content to the UDM; and;
a second sending module 1003, configured for sending a setting response message to the UE, wherein the setting response message is for notifying the UE that the updated file information content has been synchronized to the UDM.

Referring to FIG. 11, FIG. 11 is a block diagram of an application programming interface API invoking apparatus according to an example. The apparatus is applied to a Unified Data Management (UDM), including:
an obtaining module 1101, configured for obtaining updated file information content provided by an Access and Mobility Management Function (AMF), wherein the updated file information content is from an authorization configuration file of a user equipment (UE), and the authorization configuration file is for authorizing other UEs or application functions (AFs) to obtain, modify, or set a target resource of the UE;
a first determining module 1102, configured for determining an updated authorization configuration file based on the updated file information content; and
a third sending module 1103 is configured for sending the updated authorization configuration file to a Common API Framework for 3GPP Northbound APIs (CAPIF) function that subscribes to the authorization configuration file.

Referring to FIG. 12, FIG. 12 is a block diagram of an application programming interface API invoking apparatus according to an example. The apparatus is applied to an API invoker, including:
a fourth sending module 1201, configured for sending an authorization request message to a Common API Framework for 3GPP Northbound APIs (CAPIF) authentication and authorization function, wherein the authorization request message is for requesting to obtaining authorization of a target resource;
a third receiving module 1202, configured for receiving an authorization response message returned by the CAPIF authentication and authorization function, wherein the authorization response message is for indicating whether a target resource owner agrees to an authorization request of the API invoker;
a fifth sending module 1203, configured for, if the authorization response message indicates that the target resource owner agrees to the authorization request of the API invoker, sending a service API invocation request message to an API Exposure Function (AEF) based on a token provided by the CAPIF authentication and authorization function, wherein the token is for authorizing the API invoker to obtain, modify, or set the target resource; and
a fourth receiving module 1204, configured for receiving a service API invocation response message returned by the AEF, wherein the service API invocation response message carries the target resource.

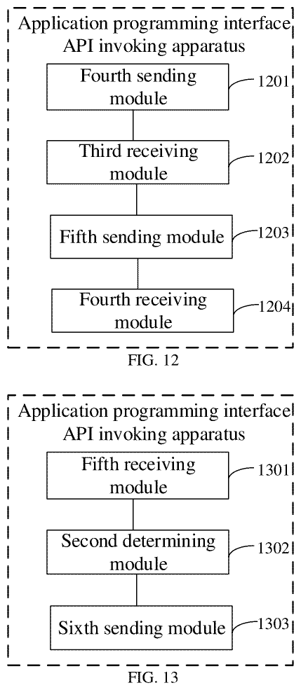

Referring to FIG. 13, FIG. 13 is a block diagram of an application programming interface API invoking apparatus according to an example. The apparatus is applied to a Common API Framework for 3GPP Northbound APIs (CAPIF) authorization function, including:
a fifth receiving module 1301, configured for receiving an authorization request message sent by an API invoker, wherein the authorization request message is for requesting to obtain authorization of a target resource;
a second determining module 1302, configured for determining, according to an authorization configuration file corresponding to a target resource owner, whether the target resource owner agrees to the authorization request of the API invoker; and
a sixth sending module 1303, configured for sending an authorization response message to the API invoker, wherein the authorization response message is for indicating whether the target resource owner agrees to the authorization request of the API invoker.

Referring to FIG. 14, FIG. 14 is a block diagram of an application programming interface API invoking apparatus according to an example. The apparatus is applied to an API Exposure Function (AEF), including:
a sixth receiving module 1401, configured for receiving a service API invocation request message sent by an API invoker;
a third determining module 1402, configured for determining a verification result of verifying the token if the service API invocation request message carries a token, wherein the token is for authorizing the API invoker to obtain, modify, or set a target resource of a target resource owner; and
a seventh sending module 1403, configured for, if the verification result indicates that the token is valid and information in the service API invocation request message matches information in the token, sending a service API invocation response message to the API invoker, wherein the response message for invoking the service API carries the target resource.

For the apparatus embodiments, since they basically correspond to the method embodiments, reference may be made to some descriptions of the method embodiments. The apparatus embodiments described above are merely illustrative, where the units described above as separate components may or may not be physically separate, and the components displayed as units may or may not be physical units, that is, may be located in one place, or may be distributed on multiple network units. Some or all of the modules may be selected according to actual needs to achieve the purpose of the present disclosure. Those skilled in the art can understand and implement the present disclosure without any creative work.

Correspondingly, the present disclosure further provides a computer readable storage medium, where the storage medium stores a computer program, and the computer program is configured for performing the application programming interface (API) invoking method according to any one of the above embodiments in the UE side.

Correspondingly, the present disclosure further provides a computer-readable storage medium, where the storage medium stores a computer program, and the computer program is configured for performing the application programming interface (API) invoking method according to any one of the above embodiments in the AMF side.

Correspondingly, the present disclosure further provides a computer-readable storage medium, where the storage medium stores a computer program, and the computer program is configured for performing the application programming interface (API) invoking method according to any one of the above embodiments in the UDM side.

Correspondingly, the present disclosure further provides a computer readable storage medium, where the storage medium stores a computer program, and the computer program is configured for performing the application programming interface (API) invoking method according to any one of the above embodiments in the API invoker side.

Correspondingly, the present disclosure further provides a computer readable storage medium, where the storage medium stores a computer program, and the computer program is configured for performing the application programming interface (API) invoking method according to any one of the above embodiments in the CAPIF authorization side.

Correspondingly, the present disclosure further provides a computer-readable storage medium, where the storage medium stores a computer program, and the computer program is configured for performing the application programming interface (API) invoking method according to any one of the above embodiments in the AEF side.

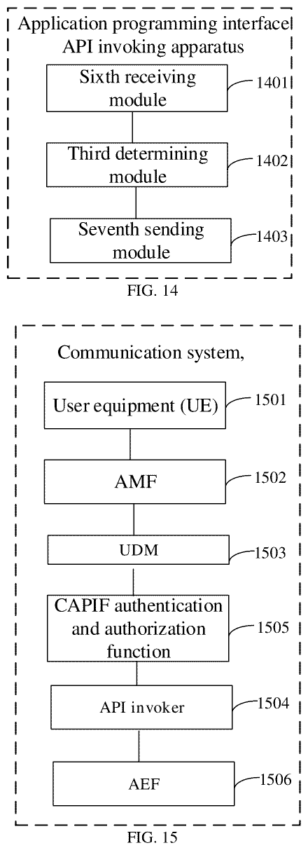

Correspondingly, the present disclosure further provides a communication system, referring to FIG. 15, which is a structural block diagram of a communication system according to an example. The communication system includes:
a user equipment (UE) 1501, configured for performing the application programming interface (API) invoking method according to any one of the above embodiments in the UE side;
an Access and Mobility Management Function (AMF) 1502, configured for performing the application programming interface (API) invoking method according to any one of the above embodiments in the AMF side;
a Unified Data Management (UDM) 1503, configured for performing the application programming interface (API) invoking method according to any one of the above embodiments in the UDM side;
an API invoker 1504, configured for performing the application programming interface (API) invoking method according to any one of the above embodiments in the API invoker side;
a CAPIF authentication and authorization function 1505, configured for performing the application programming interface (API) invoking method according to any one of the above embodiments in the CAPIF authentication and authorization function side;
an API Exposure Function AEF 1506, configured for performing the application programming interface (API) invoking method according to any one of the above embodiments in the AEF side.

Correspondingly, the present disclosure further provides an application program interface API invoking apparatus, including:
a processor; and
a memory for storing processor-executable instructions;
wherein the processor is configured for performing the application programming interface (API) invoking method according to any one of the above embodiments in the UE side.

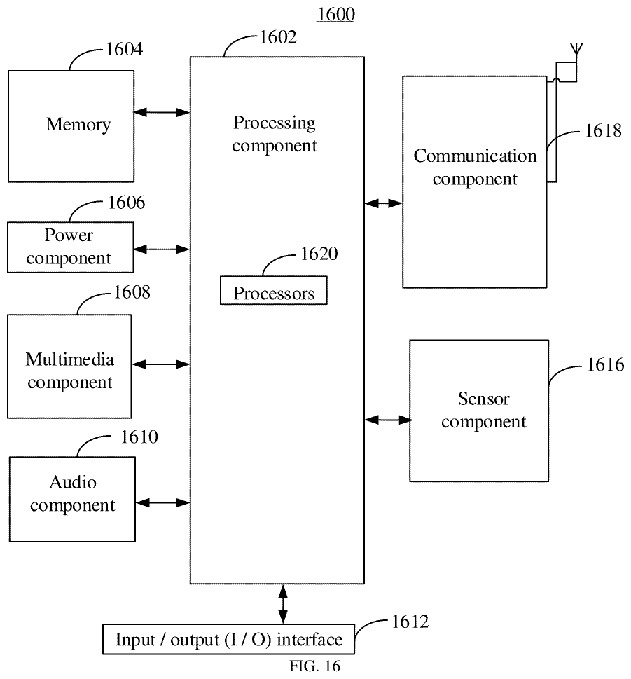

FIG. 16 is a block diagram of an application programming interface API invoking apparatus according to an example. For example, the apparatus 1600 may be a mobile phone, a computer, a digital broadcast terminal, a messaging device, a game console, a tablet device, a medical device, a fitness device, a personal digital assistant, or the like.

Referring to FIG. 16, the apparatus 1600 may include one or more of the following components: a processing component 1602, a memory 1604, a power component 1606, a multimedia component 1608, an audio component 1610, an input/output (I/O) interface 1612, a sensor component 1616, and a communication component 1618.

The processing component 1602 generally controls overall operations of the device 1600, such as operations associated with display, telephone calls, data communications, camera operations, and recording operations. The processing component 1602 may include one or more processors 1620 to execute instructions to perform all or part of the steps of the foregoing method. In addition, the processing component 1602 may include one or more modules to facilitate interaction between the processing component 1602 and other components. For example, the processing component 1602 may include a multimedia module to facilitate interaction between the multimedia component 1608 and the processing component 1602.

One of the processors 1620 in the processing component 1602 may be configured to perform the application programming interface (API) invoking method according to any one of the above embodiments in the terminal device side.

The memory 1604 is configured to store various types of data to support operations of the apparatus 1600. Examples of such data include instructions for any application or method operating on the device 1600, contact data, phonebook data, messages, pictures, videos, etc. The memory 1604 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 1606 provides power to various components of the device 1600. The power component 1606 may include a power management system, one or more power sources, and other components associated with generating, managing, and distributing power for the device 1600.

The multimedia component 1608 includes a screen providing an output interface between the device 1600 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 1608 includes a front camera and/or a rear camera. When the apparatus 1600 is in an operation mode, such as a photographing mode or a video mode, the front camera and/or the rear camera may receive external multimedia data. Each of the front camera and the rear camera may be a fixed optical lens system or have focal length and optical zoom capability.

The audio component 1610 is configured to output and/or input audio signals. For example, the audio component 1610 includes a microphone (MIC) configured to receive an external audio signal when the device 1600 is in an operation mode, such as a call mode, a recording mode, and a voice recognition mode. The received audio signal may be further stored in the memory 1604 or transmitted via the communication component 1618. In some embodiments, the audio component 1610 further includes a speaker configured to output an audio signal.

The I/O interface 1612 provides an interface between the processing component 1602 and peripheral interface modules, which may be keyboards, click wheels, buttons, etc. These buttons may include, but are not limited to, home buttons, volume buttons, start buttons, and lock buttons.

The sensor component 1616 includes one or more sensors for providing status assessments of various aspects of the apparatus 1600. For example, the sensor component 1616 may detect an open/closed state of the device 1600, relative positioning of components, such as a display and a keypad of the device 1600, a position change of the device 1600 or a component of the device 1600, a presence or absence of user contact with the device 1600, an orientation or acceleration/deceleration of the device 1600, and a temperature change of the device 1600. The sensor component 1616 may include a proximity sensor configured to detect the presence of nearby objects without any physical contact. The sensor component 1616 may also include a light sensor, such as a CMOS or CCD image sensor, for use in imaging applications. In some embodiments, the sensor component 1616 may further include an acceleration sensor, a gyroscope sensor, a magnetic sensor, a pressure sensor, or a temperature sensor.

The communication component 1618 is configured to facilitate wired or wireless communication between the apparatus 1600 and other devices. The apparatus 1600 may access a wireless network based on a communication standard, such as WiFi, 3G, 4G, 5G, 6G, or a combination thereof. In one example, the communication component 1618 receives a broadcast signal or broadcast related information from an external broadcast management system via a broadcast channel. In one example, the communication component 1618 also includes a near field communication (NFC) module to facilitate short-range communication. For example, NFC modules may be implemented based on radio frequency identification (RFID) technology, infrared data association (IrDA) technology, ultra-wideband (UWB) technology, Bluetooth (BT) technology, and other technologies.

In an example, the apparatus 1600 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform the foregoing methods.

In an example, there is further provided a non-transitory computer-readable storage medium including instructions, such as included in the memory 1504, executable by the processor 1520 of the apparatus 1500, to perform the foregoing method. For example, a non-transitory computer-readable storage medium may be a ROM, random access memory (RAM), CD-ROM, magnetic tape, floppy disk, optical data storage device, and the like.

Correspondingly, the present disclosure further provides an application program interface API invoking apparatus, including:
a processor; and
a memory for storing processor-executable instructions;
wherein the processor is configured for performing the application programming interface (API) invoking method according to any one of the above embodiments in the AMF side.

Correspondingly, the present disclosure further provides an application program interface API invoking apparatus, including:
a processor; and
a memory for storing processor-executable instructions;
wherein the processor is configured for performing the application programming interface (API) invoking method according to any one of the above embodiments in the UDM side.

Correspondingly, the present disclosure further provides an application program interface API invoking apparatus, including:
a processor; and
a memory for storing processor-executable instructions;
wherein the processor is configured for performing the application programming interface (API) invoking method according to any one of the above embodiments in the API invoker side.

Correspondingly, the present disclosure further provides an application program interface API invoking apparatus, including:
a processor; and
a memory for storing processor-executable instructions;
wherein the processor is configured for performing the application programming interface (API) invoking method according to any one of the above embodiments in the CAPIF authentication and authorization function side.

Correspondingly, the present disclosure further provides an application program interface API invoking apparatus, including:
a processor; and
a memory for storing processor-executable instructions;
wherein the processor is configured for performing the application programming interface (API) invoking method according to any one of the above embodiments in the AEF side.

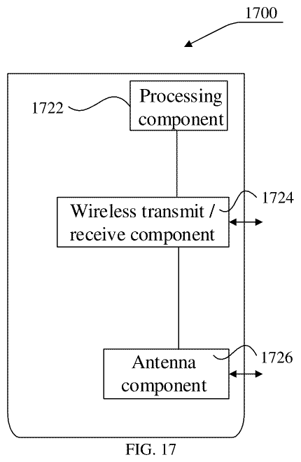

FIG. 17 is a schematic structural diagram of an application programming interface API invoking apparatus 1700 according to an example. The apparatus 1700 may be provided as any one of an AMF, a UDM, an API invoker, a CAPIF authentication authorization function, and an AEF. Referring to FIG. 17, the apparatus 1700 includes a processing component 1722, a wireless transmit/receive component 1724, an antenna component 1726, and a signal processing part specific to a wireless interface, and the processing component 1722 may further include at least one processor.

One processor in the processing component 1722 may be configured to execute any one of the application program interface API invoking methods described above.

The technical solutions provided by the embodiments of the present disclosure may include the following beneficial effects.

According to the present disclosure, the purpose of enabling user authorization in the API invoking process is achieved, and has high usability.

Other embodiments of the disclosure will be readily apparent to those skilled in the art upon consideration of the specification and practice of the present disclosures disclosed herein. The present disclosure is intended to cover any variations, uses, or adaptations of the disclosure that follow the general principles of the disclosure and include common knowledge or conventional technical means in the art not disclosed in the disclosure. The specification and embodiments are to be regarded as exemplary only, and the true scope and spirit of the present disclosure are indicated by the following claims.

It should be understood that the present disclosure is not limited to the precise structures already described above and shown in the accompanying drawings, and various modifications and changes may be made without departing from the scope thereof. The scope of the present disclosure is limited only by the appended claims.

1. An application programming interface (API) invoking method, performed by a user equipment (UE), comprising:
sending a setting request message to an Access and Mobility Management Function (AMF) in response to the UE generating or updating an authorization configuration file, wherein the authorization configuration file is configured for authorizing other UEs or Application Functions (AFs) to obtain, modify, or set a target resource of the UE, and the setting request message is configured for requesting to synchronize updated file information content in the authorization configuration file to a Unified Data Management (UDM); and
receiving a setting response message returned by the AMF, wherein the setting response message is configured for notifying the UE that the updated file information content has been synchronized to the UDM.

2. The API invoking method according to claim 1, wherein sending the setting request message to the Access and Mobility Management Function (AMF) comprises:
sending a first Non-Access Stratum (NAS) message based on a N1 interface to the AMF, wherein the first NAS message carries the updated file information content; and
wherein receiving the setting response message returned by the AMF comprises:
receiving a second NAS message returned by the AMF based on the N1 interface, wherein the second NAS message carries the setting response message.

3. (canceled)

4. The API invoking method according to claim 1, wherein the authorization configuration file comprises at least one of:
a token type that needs to be authorized to an API invoker;
an identifier of the API invoker;
an identifier of an expected service API;
an identifier of a service that the API invoker is allowed to request;
an identifier of a service operation that the API invoker is allowed to request;
an identifier of the target resource that the API invoker is allowed to request;
an identifier of a target resource owner;
a geographical area which the API invoker should be in when accessing the target resource; or
an authorization expiration time point.

5. (canceled)

6. The API invoking method according to claim 1, wherein
the AMF invokes a target service operation on the UDM to synchronize the updated file information content to the UDM.

7. (canceled)

8. (canceled)

9. The API invoking method according to claim 1, wherein
the UDM stores or updates the authorization configuration file on a Unified Data Repository (UDR); and
after the UDM determining an updated authorization configuration file based on the updated file information content, the UDM sends the updated authorization configuration file to a Common API Framework for 3GPP Northbound APIs (CAPIF) function that subscribes to the authorization configuration file.

10. (canceled)

11. The API invoking method according to claim 9, wherein the CAPIF function comprises at least one of:
a CAPIF authentication and authorization function, wherein the CAPIF authentication and authorization function comprises a CAPIF core function or an authorization function; or
an API Exposure Function (AEF).

12. (canceled)

13. (canceled)

14. An application programming interface (API) invoking method, performed by an API invoker, comprising:
sending an authorization request message to a Common API Framework for 3GPP Northbound APIs (CAPIF) authentication and authorization function, wherein the authorization request message is configured for requesting authorization of a target resource;
receiving an authorization response message returned by the CAPIF authentication and authorization function, wherein the authorization response message is configured for indicating whether a target resource owner agrees to an authorization request of the API invoker;
if the authorization response message indicates that the target resource owner agrees to the authorization request of the API invoker, sending a service API invocation request message to an API Exposure Function (AEF) based on a token provided by the CAPIF authentication and authorization function, wherein the token is configured for authorizing the API invoker to obtain, modify, or set the target resource; and
receiving a service API invocation response message returned by the AEF, wherein the service API invocation response message carries the target resource.

15. (canceled)

16. The API invoking method according to claim 14,
wherein the authorization response message carries the token; or
wherein the authorization response message carries an authorization code, and the method further comprises:
sending a first token request message to the CAPIF authentication and authorization function, wherein the first token request message carries the authorization code; and
receiving a token response message carrying the token returned by the CAPIF authentication and authorization function.

17. The API invoking method according to claim 14, wherein the authorization request message comprises at least one of:
an identifier of the API invoker;
an identifier of a service API requested by the API invoker;
an identifier of a service requested by the API invoker;
an identifier of a service operation requested by the API invoker;
an identifier of the target resource requested by the API invoker; or
an identifier of the target resource owner.

18. The API invoking method according to claim 14, wherein the token comprises at least one of:
a token type;
an identifier of the CAPIF authentication and authorization function;
an identifier of the API invoker;
an identifier of an expected service API;
an identifier of a service requested by the API invoker;
an identifier of a service operation requested by the API invoker;
an identifier of the target resource;
an identifier of the target resource owner;
a geographic area in which the API invoker accesses the target resource;
an identifier of the AEF; or
a validity expiration time point of the token.

19. (canceled)

20. The API invoking method according to claim 14, wherein sending the service API invocation request message to the API Exposure Function (AEF) based on the token provided by the CAPIF authentication and authorization function comprises:
determining the AEF to which the service API invocation request message is sent based on local configuration information or an identifier of the AEF in the token;
if the CAPIF authentication and authorization function provides a first token of which a token type is a refresh token, sending a second token request message carrying the first token to the CAPIF authentication and authorization function, wherein the second token request message is configured for requesting to obtain a second token of which a token type is an access token;
receiving the second token of which the token type is the access token returned by the CAPIF authentication and authorization function; and
sending the service API invocation request message to the AEF based on the second token; and
if the CAPIF authentication and authorization function provides a second token of which a token type is an access token, sending the service API invocation request message to the AEF based on the second token.

21. (canceled)

22. The API invoking method according to claim 14, further comprising:
performing mutual identity authentication with the CAPIF authentication and authorization function based on at least one of a certificate, a GBA, or an AKMA mechanism; and
establishing a first secure connection with the CAPIF authentication and authorization function after the mutual identity authentication with the CAPIF authentication and authorization function succeeds, wherein the API invoker sends the authorization request message to the CAPIF authentication and authorization function through the first secure connection.

23. (canceled)

24. (canceled)

25. The API invoking method according to claim 14, further comprising:
performing mutual identity authentication with the AEF based on at least one of a certificate, a GBA, or an AKMA mechanism; and
establishing a second secure connection with the AEF after the mutual identity authentication with the AEF succeeds, wherein the API invoker sends the authorization request message to the AEF through the second secure connection.

26.-28. (canceled)

29. An application programming interface (API) invoking method, performed by a Common API Framework for 3GPP Northbound APIs (CAPIF) authorization function, comprising:
receiving an authorization request message sent by an API invoker, wherein the authorization request message is configured for requesting to obtain authorization of a target resource;
determining, according to an authorization configuration file corresponding to a target resource owner, whether the target resource owner agrees to the authorization request of the API invoker; and
sending an authorization response message to the API invoker, wherein the authorization response message is configured for indicating whether the target resource owner agrees to the authorization request of the API invoker.

30.-32. (canceled)

33. The API invoking method according to claim 29, wherein if it is determined that the target resource owner agrees to the authorization request of the API invoker, the authorization response message carries a token configured for authorizing the API invoker to obtain, modify, or set the target resource; or
the authorization response message carries an authorization code; and the method further comprises:
receiving a first token request message for obtaining a token sent by the API invoker, wherein the first token request message carries the authorization code; and
sending a token response message carrying the token to the API invoker.

34. (canceled)

35. The API invoking method according to claim 29, further comprising:
if it is determined, according to the authorization configuration file, that the target resource owner agrees to the authorization request of the API invoker, generating a token constrained by the authorization configuration file for the API invoker; and
if the CAPIF authentication and authorization function provides, for the API invoker, a first token of which a token type is a refresh token,
receiving a second token request message sent when the API invoker needs to obtain the target resource, wherein the second token request message is configured for requesting to obtain a second token in which a token type is an access token, and the second token request message carries the first token; and
sending the second token of which the token type is the access token to the API invoker after verifying that the first token is valid based on the second token request message.

36.-47. (canceled)

48. The API invoking method according to claim 14, wherein the service API invocation request message comprises at least one of:
an identifier of the API invoker;
an identifier of a target resource owner;
an identifier of the target resource;
an identifier of a service API requested by the API invoker;
an identifier of a service requested by the API invoker;
an identifier of a service operation requested by the API invoker; or
the token;
wherein if the service API invocation request message does not carry the token, the AEF sends a message for rejecting invoking of the service API to the API invoker; and
if the service API invocation request message carries a token, the AEF determines a verification result of verifying the token;
if the verification result indicates that the token is valid and information in the service API invocation request message matches information in the token, the AEF sends a service API invocation response message to the API invoker; or
if the verification result indicates that the token is invalid, the AEF terminates the API invoking process.

49. (canceled)

50. The API invoking method according to claim 48, wherein determining the verification result of verifying the token comprises at least one of:
verifying, by the AEF, the token based on a public key of a Common API Framework for 3GPP Northbound APIs (CAPIF) authentication and authorization function, to determine the verification result;
sending, by the AEF, the token to a CAPIF authentication and authorization function, and receiving the verification result of verifying the token returned by the CAPIF authentication and authorization function; or
in response to determining that the service API invocation request message carries a second token of which a token type is an access token;
determining, by the AEF, the verification result of verifying the second token.

51. (canceled)

52. The API invoking method according to claim 48, wherein
if the verification result indicates that the token is valid and the information in the service API invocation request message matches the information in the token, sending, by the AEF, the service API invocation response message to the API invoker comprises:
if the authenticated first identity information of the API invoker is same as an identifier of an API invoker in the token, sending the service API invocation response message to the API invoker; or
if the identifier of the API invoker in the token is able to be mapped to the authenticated first identity information, the verification result indicates that the token is valid, sending the service API invocation response message to the API invoker.

53.-62. (canceled)

63. An application programming interface (API) invoking apparatus, comprising:
a processor; and
a memory for storing processor-executable instructions;
wherein the processor is configured to perform the API invoking method according to claim 1.

64.-68. (canceled)
